(19) United States
(12) Patent Application Publication
(10) Pub. No.: US 2015/0057063 A1
(43) Pub. Date: Feb. 26, 2015

(54) MOBILE GAMING SYSTEM AND METHOD FOR TOUCH SCREEN GAME OPERATION

(71) Applicant: PartyGaming IA Limited, Hamilton (BM)

(72) Inventors: Erik Tollstedt, Stockholm (SE); Mattias Halldin, Solna (SE)

(73) Assignee: PartyGaming IA Limited, Hamilton (BM)

(21) Appl. No.: 14/106,334

(22) Filed: Dec. 13, 2013

Related U.S. Application Data
(60) Provisional application No. 61/868,955, filed on Aug. 22, 2013.

(51) Int. Cl. G07F 17/32

(52) U.S. Cl. CPC G07F 17/3293
USPC 463/13

(57) ABSTRACT

A game with a graphical user interface displayed on a touch screen of a handheld device, wherein, player input is effected by way of touches on the touch screen; and the location of the input areas on the touch screen for the touches and the method for obtaining the necessary player game play inputs facilitate game play of a user by using the thumb of the same hand chosen by the player to hold the handheld device in one hand. Preferably, the game is poker, most preferably the game is Texas Hold'em.

### FIELD OF THE INVENTION

The present invention generally relates to mobile networked gaming systems and game methods. More particularly, the invention is directed to data input facilitators in a graphical user interface and a mobile networked poker game on a touch screen user interface.

### BACKGROUND

Several categories of networked gaming systems are well known in the prior art. A networked gaming system may be a web-based Java application, like Yahoo! Games. Further, a networked gaming system may be in the form of a downloadable software application that has a unique graphical user interface and may connect to the Internet via the back end of the software, like, for example, the PartyPoker.com client application. Even further, a networked gaming system may be in the form of a networked video game console wherein the several players in a game are connected to a network through their video game consoles (e.g., XBOX, PS3 and GAMECUBE consoles). Other categories of networked gaming systems are apparent to those persons having ordinary skill in the art, including online and mobile networked gaming systems and networked tablet gaming systems. These networked gaming systems generally are designed to accommodate two handed operation through graphical user interfaces, video game console, computer keyboards and mice.

In addition, there are stand alone games that can be played on handheld devices. In these games there is no interaction with a game server.

A player (or user) connected to a networked gaming system may choose to play one or more of the available games. In some networked gaming-systems there may be as many as hundreds of different available games. When the player finally locates the game the player would like to play, there may be multiple variations of the specific game available for play. For example, for the game of poker there may be multiple games (Texas Hold'em, Limit Hold'em, No-Limit Hold'em, Pot-Limit Hold'em, Omaha, 7-Card Stud, Razz), multiple game types (cash game, tournament, sit-and-go, freeroll), multiple game stakes (“$0.05/$0.10 Limit” through “No-Limit”), multiple game play styles (aggressive, tight) and multiple other game parameters such as game speed, disconnection protection, or skill based on the players on the table. Thus, for the game of poker, there may be thousands of available games and variations of games potentially capable of allocation to a player or selection by a player of the networked gaming system.

To facilitate networked gaming systems on a PDA (Personal Digital Assistant), Ultra Mobile Personal Computer (UMPC), smartphone, tablet or other device equipped with a touch screen interface, (collectively, “mobile device(s)”) those of ordinary skill in the art have reduced the size of the graphical interface displayed on an ordinary desktop display to accommodate the different sized touch screens of mobile devices. Simply put, the desktop graphical display is miniaturized to a smaller format and published in a mobile device format for a user to then play, in a landscape viewing mode. Features of the original game are retained, specifically computer-mouse oriented action buttons for betting, folding, calling, raising, or going “all-in.” Because of the landscape orientation of the original game, the placement of the action button areas along the bottom horizontal plane of the viewing areas, the retention of game button functions originally designed for action by computerized mouse, and the tactical difficulty of holding a rectangular PDA in one hand horizontally, the ability to hold mobile devices such as a PDA in one hand and play poker with the same hand is impossible or exceptionally difficult under present art.

The set up of a touch screen graphical user interface on mobile devices such as smart phones and the like are known from, e.g., U.S. Pat. No. 8,286,103 which is fully incorporated herein by reference. This patent describes the implementation of a slide to unlock function, on e.g. Apple Corporation's mobile phones, tablets and personal digital assistants. It also illustrates the relevant components of an electronic device including the input-output system. Yet further it describes user interface states in which actions are enabled and disabled.

### SUMMARY

The present disclosure provides one or more inventions. The disclosed embodiments allow a user to hold a touch screen equipped mobile handheld device such us a PDA or smartphone comfortably in one hand and facilitate play with the thumb of that same hand without any other steps for operation of the game. The disclosure provides a novel system combining a vertical orientation with user interaction areas designed to fall within the physical reach of the thumb of the same hand chosen by the user to hold the device, and methods for game action which allow for thumb operation, all of which permit game play with a single hand.

For the purposes of this disclosure, a handheld device means a device that can be held and operated in one hand and may fit in the pockets of most attire. Examples of such devices include personal digital assistants, mobile telephones, smartphones, tablets and personal music players.

The systems and methods described herein can operate with respect to games played by the user over the network, wherein games refer to any type of rule-based activity or contest between or amongst two or more players with goals and objectives attainable for the players. Games include but are not limited to knowledge based games (e.g. trivia games), creative games, individual or team sports games (baseball, football, soccer, hockey, golf, tennis, etc.), games of skill (poker, blackjack, bridge, etc.), role playing games, fantasy games, historical games, war games, problem-solving games, puzzle-solving games, contests, rehabilitation games, etc. Games may also include simulation events, such as the popular Flight Simulator program and the like. Herein, the invention is described mostly in terms of online poker games, and Texas Hold'em in particular.

In an embodiment, the disclosure provides a device comprising a touch screen and a graphical user interface for a card-playing game displayed on the touch screen where the area of the graphical user interface is accessible to the thumb of the same hand selected by the user to hold and operate the device, with the assumption that the size of the hand and thumb of the user is within a normal human range. Further, the user interface can include at least one thumb-initiated player action such as fold, check and call, bet and raise as these actions are known in poker.

In an embodiment, the disclosure provides a non-transitory machine-readable storage medium that includes first software instructions that, when executed by a processor, cause the processor to present a graphical user interface for a card-playing game on a touch screen and second software instructions that, when executed by the processor, cause the processor to receive user input for the game.

In an embodiment, the disclosure provides a game comprising a graphical user interface displayed on a touch screen of a handheld device, wherein:

player input is effected by way of touches on the touch screen;

the location of the input areas on the touch screen for the touches facilitate game play of a user by using the thumb of the same hand chosen by the player to hold the handheld device in one hand;

the method for obtaining the necessary player game play inputs facilitate game play of a user by using the thumb of the same hand chosen by the player to hold the handheld device in one hand.

In an embodiment, the disclosure provides a game, wherein the game is a poker game.

In an embodiment, the disclosure provides a game, wherein the poker game is Texas Hold'em.

In an embodiment, the disclosure provides a game, wherein each of one or more of touches to which the game is responsive is a slide action and consists of detecting distance of travel of a continuous touch over the touch screen.

In an embodiment, the disclosure provides a game, wherein the system detects whether the distance of travel of the continuous touch exceeds a distance threshold.

In an embodiment, the disclosure provides a game, wherein the system detects and reacts to the increase in distance or decrease in distance of a continuous touch away from a starting point across predetermined distance intervals.

In an embodiment, the disclosure provides a game, wherein at least one of the touches to which the game is response is a tap.

In an embodiment, the disclosure provides a game, wherein the calculates whether two taps are performed within a predetermined time period.

In an embodiment, the disclosure provides a game, wherein, a hole cards icon is located at a first location where the touch screen is responsive to touch, a poker chip icon is located a second location where the touch screen is responsive to touch and a third icon is located at a third location where the touch screen is responsive to touch.

In an embodiment, the disclosure provides a game, wherein:

the hole cards icon and the poker chip icon are located at a bottom portion and at opposite sides of the bottom portion of the touch screen; and

the third icon is located horizontally between the hole cards icon and the poker chip icon and vertically apart from the hole cards icon and the poker chip icon so that the hole cards icon, the poker chip icon and the third icon appear at respective corners of a triangle.

In an embodiment there is a fourth interactive icon located above the figurative triangle representing the pot of bets made during game play.

In an embodiment there is a fifth interactive icon located beneath the figurative triangle representing a plus or minus sign and “slider” bar for betting action including increasing or decreasing bets in amounts between the range of amounts predetermined by the game server to be the minimum or maximum bets available to the player at the time of his or her turn.

In an embodiment, the disclosure provides a game comprising the steps of:

causing display of a graphical user interface on a touch screen of a handheld device;

causing display of a plurality of icons on the graphical user interface at locations where detection of touching of the touch is enabled;

detecting touching of the touch screen to an area capable of being reached by the thumb of same hand used by a player to hold the handheld device in one hand.

In an embodiment, the disclosure provides a game, wherein the step of causing the display of a plurality of icons comprising causing the display of a hole cards icon located at a first location where the touch screen is responsive to touch, a poker chip icon located a second location where the touch screen is responsive to touch, a third icon located at a third location where the touch screen is responsive to touch, a fourth icon located above the figurative triangle of the first through third icons where the touch screen is responsive to touch, a fifth icon located beneath the figurative triangle of the first through third icons where the touch screen is responsive to touch.

It should be noted that in other embodiments, these five game play action icons may or may not all be present and may be configured in other locations of the touch screen provided that they may be reached and operated by the thumb of the same hand holding the mobile device.

In an embodiment, the disclosure provides a networked game, comprising:

a game server that controls game play and sends game state information to connected handheld devices of players;

a network via which the handheld device can be connected to the game server; and

the handheld devices connected to the game server,

wherein,

each handheld device comprises a touch screen,

for each handheld device, player input is effected by way of touches on the touch screen; and

for each handheld device, the location of the input areas on the touch screen for the touches and the method for obtaining the necessary player game play inputs facilitate game play of a user by using the thumb of the same hand chosen by the player to hold the handheld device in one hand.

In an embodiment, the disclosure provides a networked game, wherein the game is a poker game.

In an embodiment, the disclosure provides a networked game, wherein the poker game is Texas Hold'em.

In an embodiment, the disclosure provides a networked game, wherein each of one or more of touches to which the game is responsive is a slide action and consists of detecting distance of travel of a continuous touch over the touch screen.

In an embodiment, the disclosure provides a networked game, wherein the system detects whether the distance of travel of the continuous touch exceeds a distance threshold.

In an embodiment, the disclosure provides a networked game, wherein the system detects and reacts to the increase in distance or decrease in distance of a continuous touch away from a starting point across predetermined distance intervals.

In an embodiment, the disclosure provides a networked game, wherein at least one of the touches to which the game is responsive is a tap.

Additional features and advantages of the disclosure will be set forth in the description which follows, and in part will be apparent from the description. The objectives and other advantages of the invention will be realized and attained by the structure particularly pointed out in the exemplary embodiments in the written description and claims hereof as well as the appended drawings.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 depicts a mobile networked gaming arrangement according to an exemplary embodiment.

FIG. 2 depicts a screenshot of a poker table for a mobile device according to an exemplary embodiment.

FIG. 3 depicts a screenshot of poker table for a mobile device according to an exemplary embodiment together with general areas reached by thumbs of a player.

FIG. 3A depicts a handheld mobile device held in a hand of a user.

FIG. 4 depicts a screen shot with a fold action enabled in accordance with an exemplary embodiment.

FIGS. 5A-5C illustrate a fold by a two tapping action in accordance with an exemplary embodiment.

FIGS. 6A-6D illustrate a fold by a sliding action in accordance with an exemplary embodiment.

FIG. 7 depicts a flow chart of implementation of a fold by sliding action in accordance with an exemplary embodiment.

FIG. 8 depicts a screen shot with a check action enabled in accordance with an exemplary embodiment.

FIG. 9 depicts a flow chart of implementation of a check a by double tapping action in accordance with an exemplary embodiment.

FIG. 10 depicts a screen shot with either a call, bet or raise action enabled in accordance with an exemplary embodiment.

FIG. 11 depicts a flow chart of implementation of a call, bet or raise action in accordance with an exemplary embodiment.

FIG. 12 depicts a mobile gaming system architecture environment.

FIGS. 13-16 depict messaging sequence diagrams various betting rounds for Texas Hold'em poker gameplay in accordance with an exemplary embodiment.

FIG. 17 depicts an embodiment of the screen reflecting three overlay messages in the context of a preflop round for Texas Hold'em poker gameplay.

### DETAILED DESCRIPTION

Various embodiments and aspects of the invention will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present invention.

A game server (sometimes host or share) is a server, which is the authoritative source of events in a networked system game for one or more than one player. The server transmits enough data about its internal state to allow its connected clients to maintain their own accurate version of the game world for display to a single player or multiple players. The game server also receives and processes each player input. In most online gaming systems, the game server comprises one or more dedicated remote processing units configured to run logical code to serve up the games to the players, who interact with the game server via clients or terminals, usually in the form of personal computers, tablets, PDAs, UMPCs, and so-called “smart” cellular telephones. The game servers generally are in communication with data storage systems on which are stored data used in the served games, e.g., player histories, game data, etc.

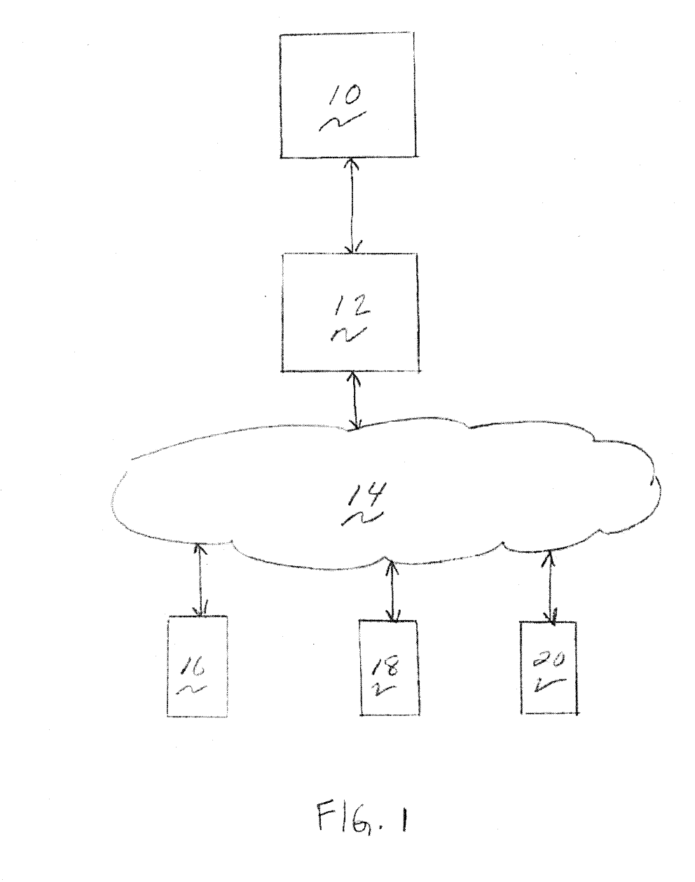

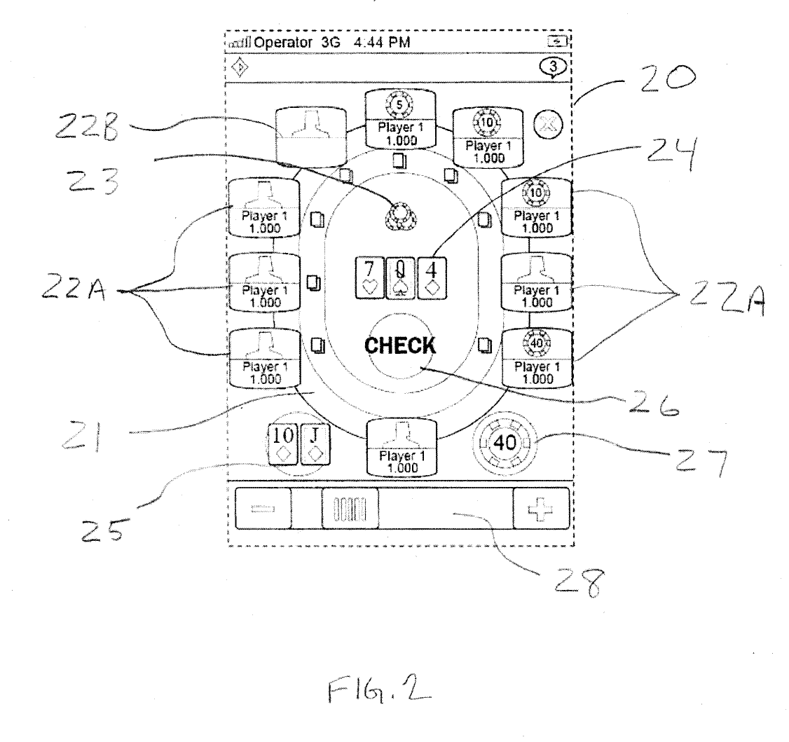

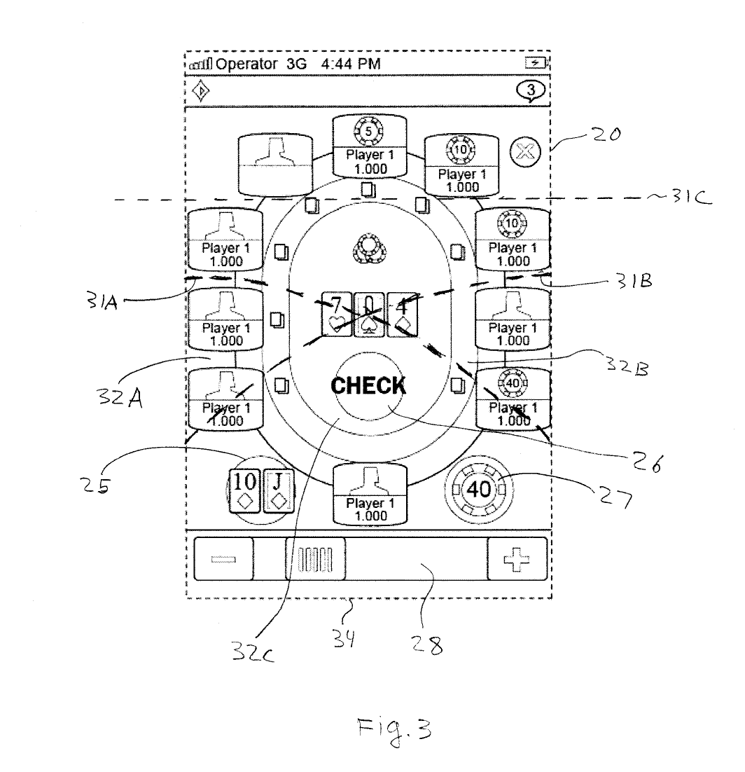

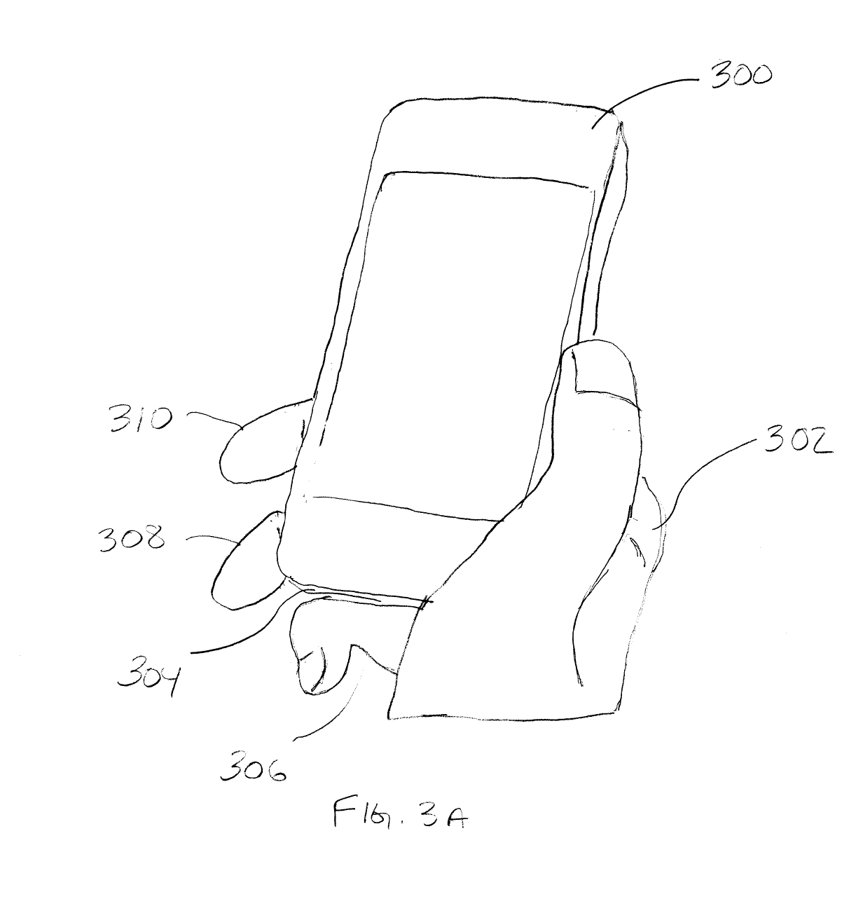

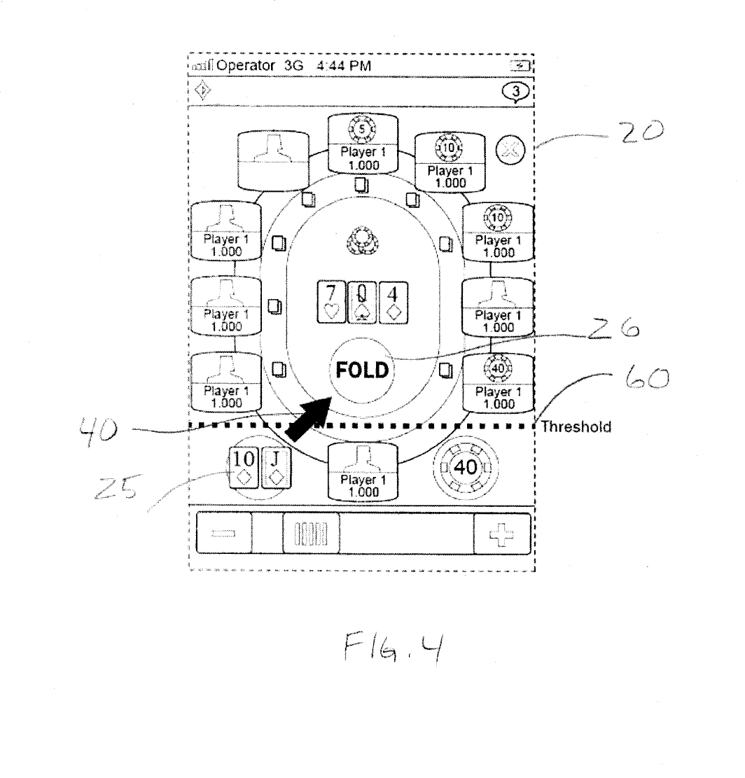

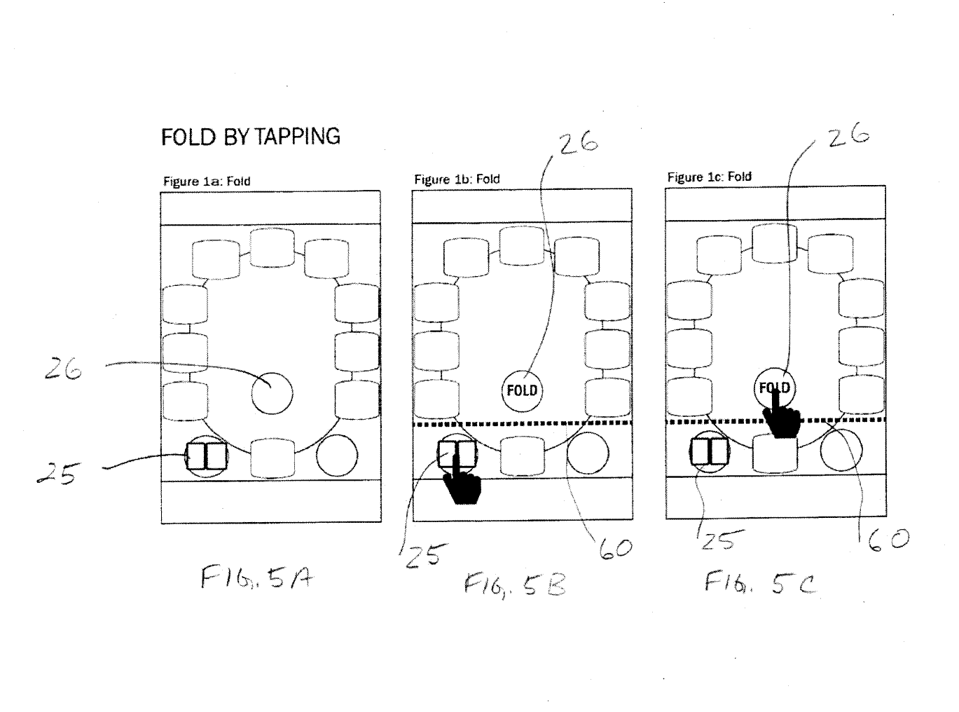

In FIG. 1 there is illustrated a game server 10 representative of the one or more remote processing units and their associated memories or data storage units running logic that effect a game program. Clients 16, 18, and 20 are representative of touch screen equipped devices, including mobile devices of the one or more players who interact with the game server to play the one or more games served up by the game server. Network 14 is representative of the various public or private networks, such as a local area networks or wide area networks via which the clients 16, 18, and 20 and the server computers 10 interconnect and communicate with each other. The connection can be via wires, ethernet being one of many such connections, or via wireless communications, cellular networks and Wi-Fi connections being just two of many such connections. The clients may run local logical code in the form of programs or applications in order to interact with the game server. One such reason is to provide secure connections.

The clients 16, 18, and 20 may be any type of touch screen equipped computing device that is capable of allowing a user or player to interface and interoperate with gaming software executing locally (i.e. on the game playing device 16, 18, and 20) or remotely (i.e. on another computing device, e.g. the server 10, interconnected over the network 14). Described herein is a system in which the locally executed software is Javascript™ based coding as is used in many mobile device games. Javascript™ is an interpreted computer programming language used in many games, particularly games played on mobile devices. Client-side script interacts with the user. The user's gaming device then may communicate with a game server, which provides game state updates as appropriate. Many mobile networked games utilize Javascript™ user interfaces. However, the principles of the invention could be translated into other environments and coding schemes.

The gaming server 10 communicates with the clients 16, 18, and 20 via an intermediary translation server 12, preferably a well-known LightStreamer™ server which provides for bi-directional messaging for mobile and web applications. Essentially, the server 12 translates messages into the protocols used by the game server and the mobile device as appropriate.

The gaming services to be described herein are shown as executing on a single platform, but of course may be distributed across multiple platforms as may be desired or required (e.g. for appropriate scalability, etc.). Distribution of services as described herein are well known in the art and need not be described in further detail.

In FIG. 2 there is illustrated a screenshot 20 of a mobile device including a graphical user interface for a poker game, a Texas Hold'em poker game in particular. The graphical user interface includes a depiction of the poker table 21 around which are virtually seated players in the form of player icons 22. Player icons 22A, which include some relevant player information, indicate that the associated players are present in the game and virtually seated at table 21. Player icon 22B indicates an open seat at the table 21 because there is no player information for that icon.

Also situated on the table 21 is a graphical representation of poker chips 23 representative of a pot. A graphical representation or icon 24 of open faced cards represents the community cards utilized in Texas Hold'em poker.

In addition, the graphical user interface includes five active icons or graphical depictions 23, 25, 26, 27 and 28 described in greater detail below. It is noted at this point that it is by way of these icons that a user interacts with the graphical user interface and plays the game.

In FIG. 3, the screenshot 20 is again illustrated with the graphical user interface but this time with various generally delimited areas described next. These delimited areas are delimited by three lines: curved line or arc 31A, curved line or arc 31B and a rectilinear horizontal line 34 spanning the bottom of the screenshot 20. Areas 32A, 32B and 32C are delimited by these lines and are an example of areas of the graphical display that the thumb of the operating hand may easily reach without further movement or manipulation of the device in the hand. Each of areas 32A and 32B is defined by a radius extending from a corner of the device where a user's thumb would likely be positioned. For example, in an orientation shown in the exemplary embodiment in FIG. 3, the radius extends from a lower left corner or a lower right corner depending upon whether the user intends to use a left hand or right hand, respectively. Depending on the size of the touch screen, the radius may extend to cover as much as ½; ⅓; ¾ or the entire touch screen, and ranges between. As hand held devices have become smaller both vertically and horizontally, it is anticipated that the example area includes, for many persons, the pot icon 23.

As can be appreciated, line 31A represents the outer relaxed reach of a left thumb of a person holding the mobile device in a vertical orientation in their left hand, whereas line 31B represents the outer relaxed reach of a right thumb of a person holding the mobile device in a vertical orientation in their right hand, Area 32A is that area of the user interface under line 31A that is within the relaxed reach of the left thumb if the device is held by the left hand. Area 32B in that area of the user interface, under line 31B that is within the relaxed reach of the right thumb if the device is held by the right hand. Area 32C is that area overlapped by both areas 32A and 32B, and is cross-hatched in FIG. 3 for case of reference.

FIG. 3 also include a horizontal line 31C dividing the screen into approximately and an upper quarter section or area and a lower three-quarters section or area. The lower approximately three-quarters area represents the general area of a handheld touch screen device that can be reached by the thumb of the hand of the user holding the device without manipulating the device to move it downward in the palm of the hand.

In FIG. 3A, a device 300 is illustrated as representative of various handheld devices. A typical way in which such a device 300 is held in a hand 302 is illustrated. As shown, the device 300 typically is held such that a bottom 304 thereof rests on top of a pinky finger 306, and the device is cradle within the palm of the hand 302. The two middle fingers 308 and 310 grip the device 300 and the index finger (not shown) supports the device 300 at the backside thereof.

To ensure ergonomic operation of the mobile device by a single hand or single digit such as a thumb, the primary controls or active icons 25, 26, 27 and 28 requiring player input are located within area 32C, and control icon 23 is also reachable by the thumb of the same hand holding the device by a user intending to operate the game with a same hand holding the device. The general shape of the user interface is not limited to a specific shape as shown in FIG. 3. Rather, the shape of the user interface is that of any shape whose area could easily be reached by the thumb of a user's hand while holding the device in the same hand. However, it is noted that the icons 25, 26 and 27 are positioned at the vertices of a triangle, preferably an isosceles triangle. Additionally, the positions of the icons 25 and 27 can easily be reversed and still maintain the functionality described herein. The system may be configured by a user's predetermined settings to allow such a reversal of icons or indeed readjustment of basic settings to reposition action icons to accommodate any personal preferences for use or ease of access by the user.

Additionally, the location of the primary controls may change with the direction that the device is oriented, for example if the device is held in the hand of the user horizontally or vertically, so long as the orientation of the graphical user interface also changes accordingly. Further, the manner in which the device is held or manipulated by the user, i.e., in the palm of the user's hand or with the user's fingertips may extend or decrease the area of the touch screen that the thumb of the same hand holding the device may reach.

As mentioned above, in an embodiment, the present invention is implemented using the Javascript™ and HTML5 coding and capabilities. The client, or mobile device does not actually run the game, but rather changes displayed graphics and state in response to messages received from the game server. All game logic and game states are determined by the game server and distributed to the various game clients. There is a single message stream between the game server and the game clients and the messages in the stream are handled base on message identifiers (IDs). Communication from a game client to the game server are thus restricted to login information, game selection and game actions with action being time span limited.

With touch screen devices, such as those based on the iOS and Android operating systems, the coding permits the occurrence and recognition of events such as a touch event. The availability of the event can be restricted to one or more areas on the screen, and the occurrence of a touch event can be captured. The exemplary embodiment makes use of the ability to capture touch events to provide the functionality described herein.

Prior to game play, a mobile device may contact a game server and receive information regarding available games and other related information. And, as noted earlier, the present invention is described herein in the context of the networked Texas Hold'em poker game.

In Texas Hold'em, each player is dealt two cards, called hole cards, and then all players ultimately share five community cards and the object, typically, is for each player to make the best poker hand out of their two hole card plus any three of the five community cards. The community cards are laid face up on the table and all players can use them in combination with their own hole cards to make the strongest 5 card hand. The five community cards, however, do not all get dealt at the same time. This is to accommodate betting during certain intervals in the deal.

Game play for each hand starts with an ante made by two players in the form of a “big blind” and “little blind” placed, respectively, by the two players to the immediate left of the player designated as the “dealer” for that hand. The dealer “button” moves after each hand in clockwise fashion. Next, hole cards are dealt to all players. The first round of betting occurs before any community cards are dealt, and this round of betting called the “pre-flop.”

Then, three of the five community cards are dealt at one time on the board. This is known as the “flop” round. After the “flop” cards (the first three community cards) are dealt, there is another round of betting.

The deal of the fourth card community card is called the “turn” and this takes place during the “turn” round. After the “turn” card (the fourth community card) is dealt, there is another round of betting.

The deal of the final, fifth community card is known as the “river.” After the “river” card (the fifth community card) is dealt, there is another and final round of betting. Once betting is concluded, if more than one player has called all bets or otherwise wagered all chips in the player's “stack” at the commencement of that hand (this betting action is called “all-in”), then the game proceeds to a final “show down” where a winner or winners are determined by the game server. Typically, the hole cards of the players for the winning hand or hands at show down are made visible to all players. Depending upon the rules and policies of the gaming operator, the system may be configured such that losing players may select predetermined player preferences stored in the personal player information database as to whether they will show, not show (“muck”) or be given the option at the conclusion of the hand to show one or both of their hole cards. Where only one player remains because no other player has called the bet or all other players have folded, depending upon the rules and policies of the gaming operator, the system may be configured such that winning players may select predetermined player preferences stored in the personal player information database as to whether they will show, not show (“muck”) or be given the option at the conclusion of the hand to show one or both of their hole cards.

After the winner or winners are determined by the game server and the pot or share of the pot is electronically transferred to the stack of the winner or winners, the game play cycle resumes by movement of the dealer button clockwise, antes, and dealing of the hole cards.

At any of the betting rounds, a game client is permitted three basic operations: 1) fold, 2) check, and 3) bet (make a new bet, call an existing bet, or raise an existing bet). A player may also leave the table at any time, and the system treats such an action as a fold if there is an active hand in which the player has not already folded. In an embodiment depicted in FIG. 4, the decision to leave the table is initiated in the game by tapping the area or “X” symbol 20 for close. The implementation of these functions is discussed next.

It should be understood that the Javascript™ coding executed on the game device will detect touches within certain restricted areas of the display screen. For the purposes of this invention, those certain areas are areas respectively occupied by the circle icon or action indicator icon 26 on the table, the hole cards icon 25 at the bottom left-hand portion of the screen, and the poker chip or “call/bet/raise” icon 27 on the bottom right-hand portion of the screen and the “pot” icon 23 located above the community card section near the center of the screen. These icons can also be referred to as graphics. There also is a slider function that is used in connection with the call/bet/raise function, and that is associated with the slider graphic icon 28 across a bottom portion of the screen.

After a user has logged in and joined a table in the known way, and the table is ready for a new game, the server 10 will serve up a new game. The server will then control game play through the blind, pre-flop, flop, return, river and showdown rounds. In addition, the server 10 will send appropriate messages to the mobile devices of cell players to update their views of the game state, i.e. the poker table.

In any event, at the beginning of a player's turn, an “optionset” message is sent to the player's game device informing the device as to what actions the player can perform during that turn. Depending on the actions allowed/enabled, corresponding icons on the screen are enabled. Fold is always an option, and always enabled.

Fold

The fold function can be effected in two alternative ways. One way is a two-tapping action by the player. The other is a sliding action. These two actions are described next in connection with FIGS. 4-7.

First, when a mobile device is set to enable a player to take their turn, i.e., in a start of turn state, the fold action becomes enabled, i.e. the touch screen is enable to accept touch information via the hole cards icon 25 region. This is illustrated in FIG. 5A. A tap or touch of the hole cards icon 25 will cause the overlay graphic with the text or word “FOLD” to appear over the action indicator icon 26, as illustrated in FIGS. 4 and 5B. The threshold 60, described later, preferably is an invisible threshold, i.e., there is no line shown on the display. The arrow 40, in FIG. 4 is merely to indicate herein a desirable movement of the hole cards icon 25, once the “FOLD” overlay graphic is displayed.

With reference to FIGS. 5A-5C, the two-tap fold action will be described. In the two-tap action, the fold function is performed by a first tapping of the player's hole cards icon 25 at the bottom left-hand portion of the screen, as illustrated in FIG. 58, followed by another tapping of the action indicator icon 26, as illustrated in FIG. 5C. The first player tap of the hole cards icon 25 is captured by the Javascript™ coding. At that time, as described above, an overlay graphic with the text or word “FOLD” is displayed over the action indicator icon 26 and a timer is initiated. If the player does not tap the action indicator icon within an allotted time period, the overlay “FOLD” graphic is removed and the game is reset to the player's turn. If the player does tap the action indicator icon a second time within the allotted time frame, the selection is captured and communicated to the game server 10, the fold function is effected by the game server, and play continues as appropriate.

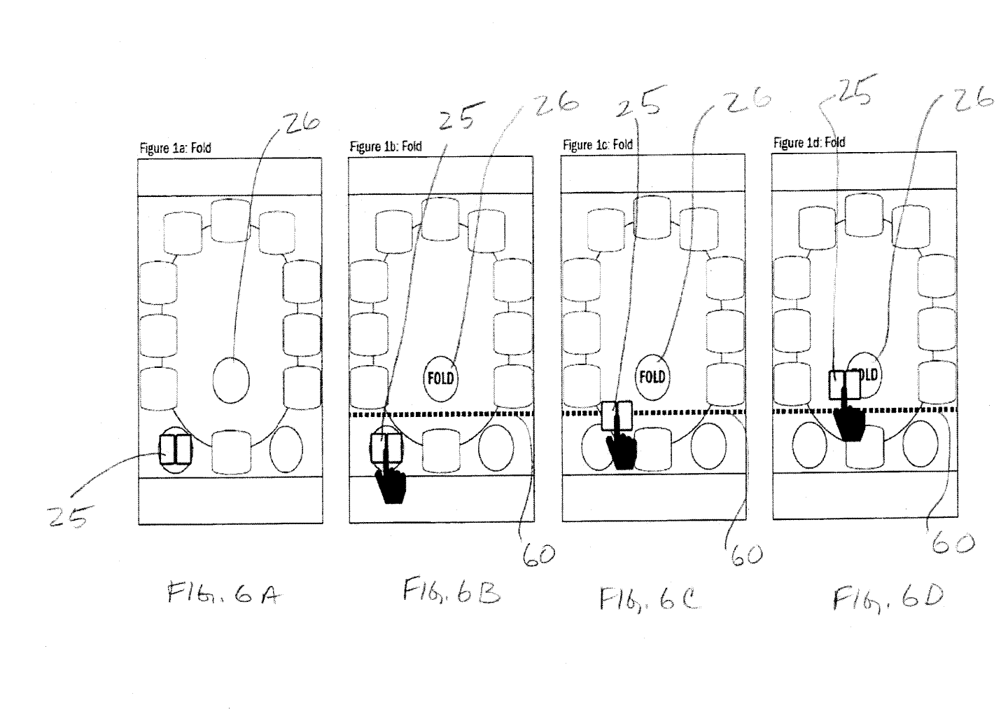

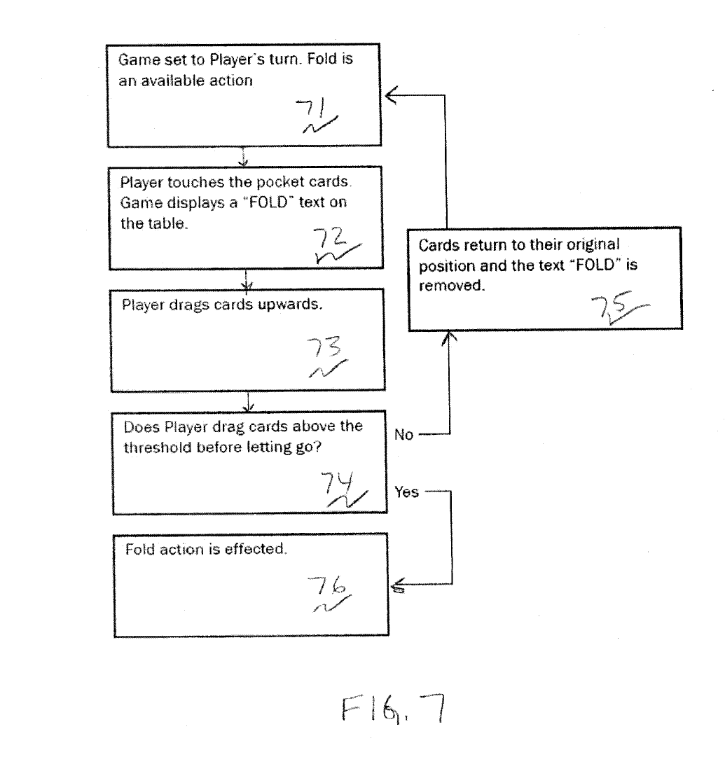

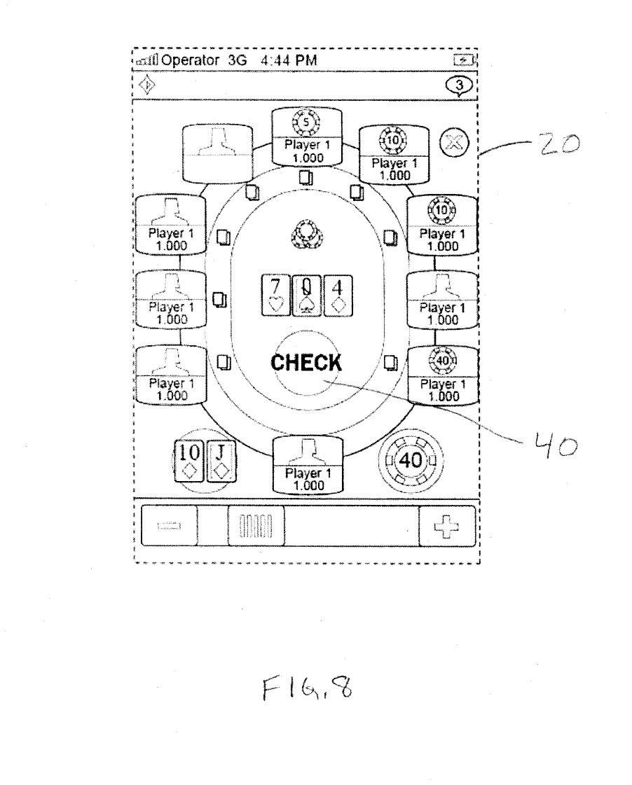

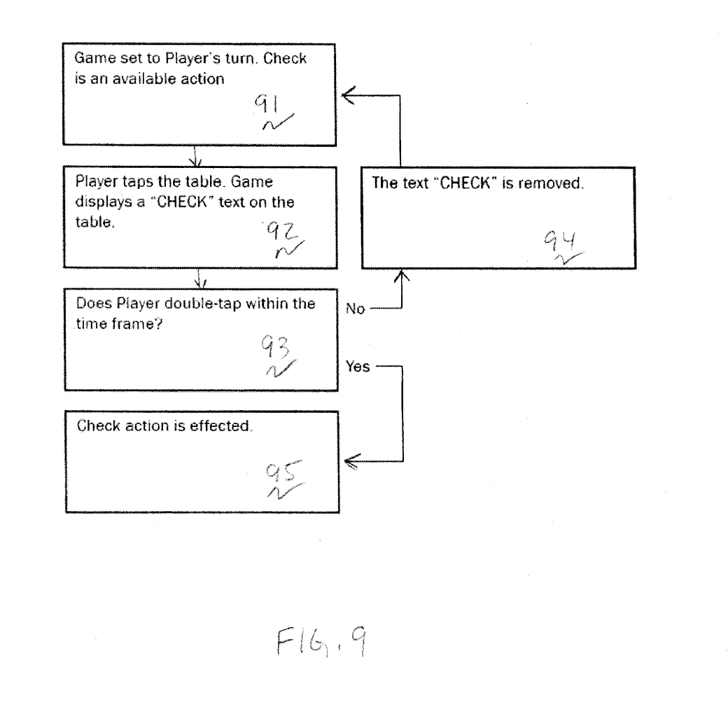

The alternative fold sliding action is described in connection with FIGS. 6A-6D and 7. In the alternative sliding action, in step 71, the mobile device is set to the player's turn, as illustrated in FIG. 6A. As a first action, in step 72 the player touches their hole cards icon 25, and the touch will be captured by the Javascript™ coding. At that time, a graphic of the word “FOLD” will appear over the action indicator icon 26 as previously described. The player then drags the icon upward i.e. vertically toward the threshold 60, in step 73. If the player lets go of the hole cards icon 25, by lifting his or her finger or otherwise no longer touching the screen, without having moved the hole cards icon beyond a threshold 60 extending across the screen, the overlay “FOLD” graphic is removed and the player's turn is reset as set forth in step 75. In an embodiment, a timer is provided for the player to make his move, such as by tapping twice or dragging. If the player does move the hole cards icon 25 beyond the threshold, the fold selection is communicated to the game server 10 in step 74, the function is effected by the game server and play continues as appropriate as set forth in step 76.

Preferably, the icon 25 is animated and will follow a moving touch across the screen of the mobile device, at least as far as the threshold 60. Thus, as illustrated in FIGS. 6C and 6D, the icon 25 preferably translates across the screen in tandem with the user's touching finger, usually a thumb, although our index finger is used in the illustrations.

In both fold actions, the action is effected by validating the previously received “optionset” message (fold is always valid). An “option” message is generated describing the action with and ID and an amount, which in the case of a fold is zero. The message is serialized and sent to the game server via the LightStreamer server, which translates the message into the format appropriate for the game server.

Regarding the threshold 60, the system recognizes when the hole cards icon 25 has moved a pre-established minimum distance, for example, as measured in pixels, in a vertical distance from the original located of the graphic. As an example, the distance could be 50 pixels. As can be appreciated, this distance can be calculated numerous ways, and also, the pixel distance number would vary depending upon the resolution of the screen.

The arrow 40 in FIG. 4 indicates the general direction of movement of the hole cords icon 25 will undergo in most circumstances when a right thumb is pivoted across the screen. But, as discussed, the threshold preferably is calculated only with reference to the vertical direction relative to the bottom of the screen. Of course, other schemes can be used, but would seem to be more complicated than necessary.

While not considered a part of the game play function, leaving the table by touching symbol 20 will be treated as a fold if the player remains in the hand at the time the touch is made. The system may be configured to ask for confirmation if a player wishes to leave the table by sending an overlay graphic touch responsive message from the server to the client that appears on the graphical interface. In addition, the system may measure and detect a predetermined time limit for continuous touch of the symbol 20 in order to minimize inadvertent touches. The system may also be configured to detect the departure of the client 16 from the system as a result of powering off the mobile device or other interruption of the connection between the client and the game server, and treat the same event as a fold.

Check

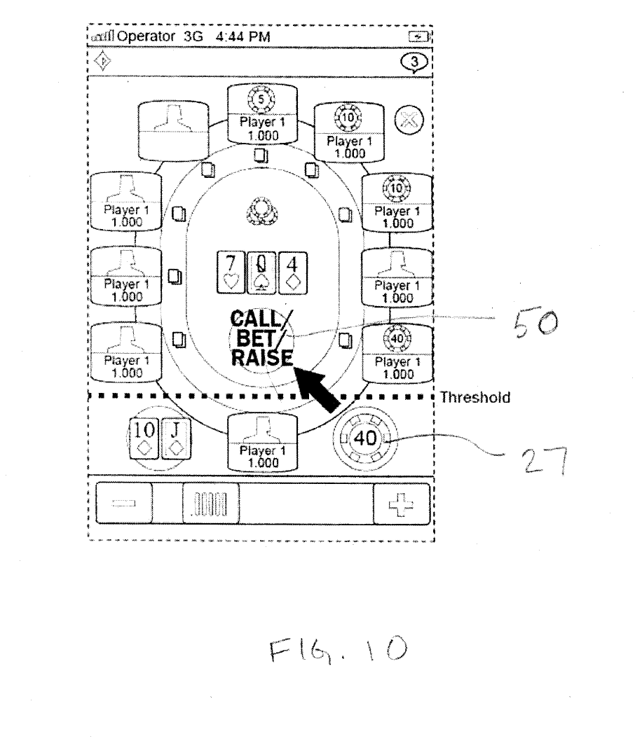

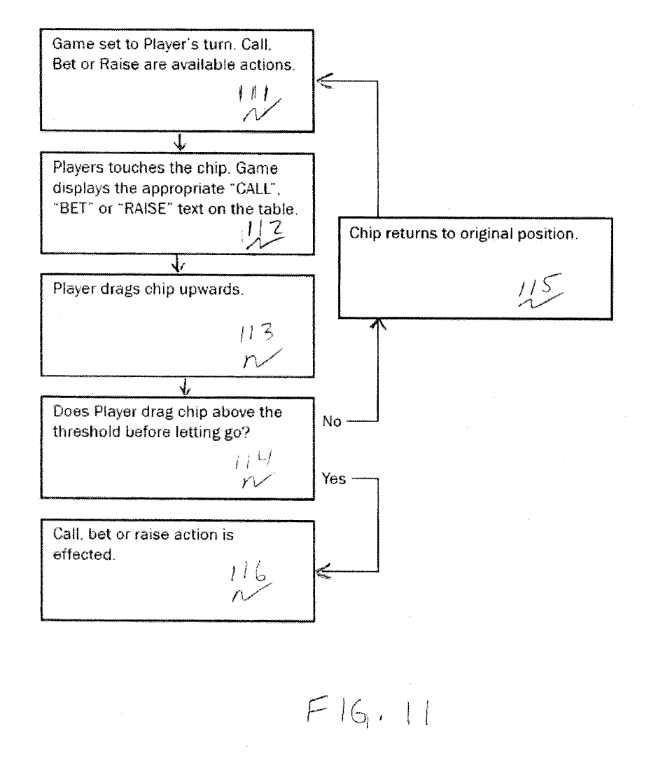

The Check function is described in connection with FIGS. 8 and 9. The check function is performed via a double tapping of the action indicator icon 26 on the table 21.

First, in step 91, the game is set to the player's turn. The check function is one of several that are available. If the player taps the action indicator icon 296 once, the tap is captured by the coding. At that time, as indicated in step 92, an overlay graphic with the text or word “CHECK” is displayed over the action indicator icon 96 and a “selection” event is sent to the server notifying the server of the initial selection of the check function. At the same time, an timer is initiated. If the player does not again tap the action indicator icon 96 within the allotted time, as determined in step 93, the overlay “CHECK” graphic is removed in step 94, a “selection cancelled” event is sent to the server and the game is reset to the beginning of the player's turn by returning to step 91. If the player does tap the action indicator icon 96 a second time within the allotted time frame, the check function is effected by the game server in step 95, and play continues as appropriate

Call/Bet/Raise

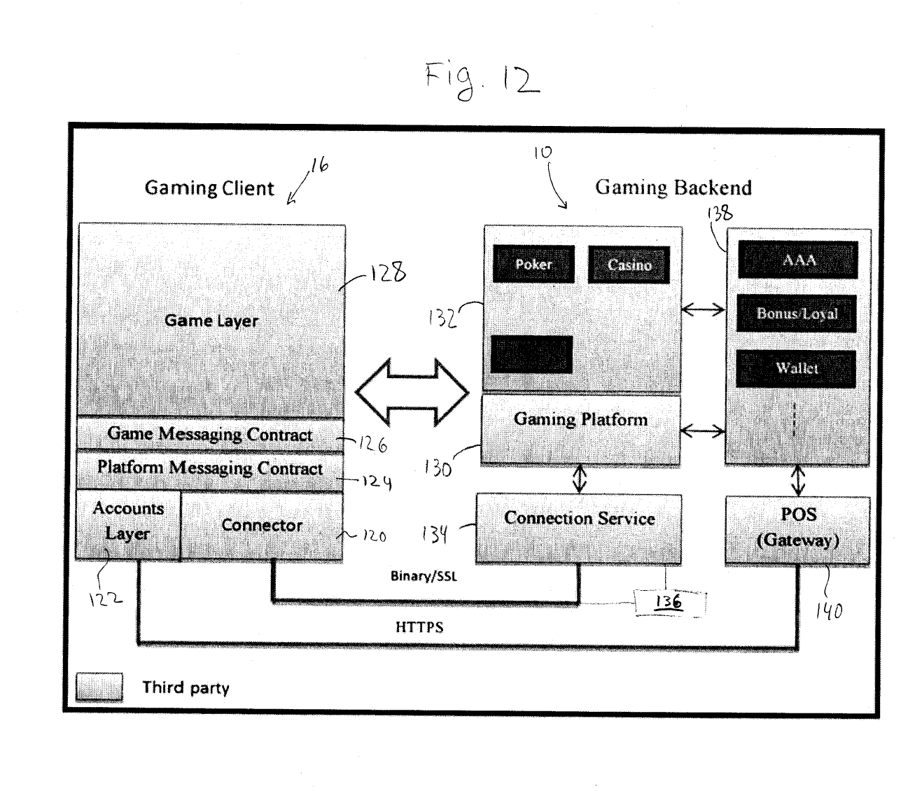

The call, bet and raise actions may be effected by tapping the poker chip icon 27 at the bottom right-hand portion of the screen and subsequent taps and manipulations of the slider graphic 28, as may be appropriate, as discussed below. As an initial matter, each tap of the poker chip icon will cause the generation of a text or word “CALL,” “BET” or “RAISE” overlay graphic 50 to be displayed over the action indicator icon 25, as shown in FIG. 10. Only one of these words will appear, all three are shown in the FIG. 10 for ease of reference. As can be appreciated repeated tapping of the poker chip icon 27 will cause the overlay graphic to cycle through the “CALL,” “BET” and “RAISE.” overlay 50 and background cycling of the selection in appropriate messages sent to the game server. Once the player has settled on or selected the desired action, the turn continues depending upon the action selected.

First, the game is set to the players turn step 111 “CALL,” “BET” and “RAISE” are made available via an appropriate optionset message from the server. Then, in step 112, the player touches the poker chip icon 27 to choose one of a “CALL”, “BET” or “RAISE” actions. The appropriate action is enabled once the player has finished cycling through the actions, as described above and the selected action is displayed by the corresponding text overlay 50. In one embodiment, the call, bet or raise are linked to the amount of money the player wants to bet. The default is bet, followed and if the player uses the slider at the bottom then the raise becomes active. If an opponent has made a bet, the player may “Call” or “Raise.” “Call” matches the current bet. Anything above that is “Raise.” If there are no bets on the table only “Bet” is available.

If a call action is desired and the “CALL” graphic is displayed over the action indicator icon 26, the player then taps on the action indicator icon 26 within an allotted time period in a manner similar to the check action. This will cause the game device to effect the required optionset message validation and to send the appropriate selection messages to the game server to allow the game to continue accordingly. “Call,” “Bet” and Raise” may then be performed by sliding the chip on the table.

In another embodiment, the chip icon 27 is enabled by the system to detect continuous touch and sliding along a predetermined distance, and that a call or bet of the amount in the chip icon 27 at the time of the touch and slide into the action area 26 will cause a bet to occur in that amount.

If a raise action is desired and the “RAISE” graphic displayed over the action indicator button icon 26, the player first must select the raise amount by manipulating the slider graphic 28 at the bottom of the screen. Sliding of the slide on the graphic 28 will cause the raise amount to increase, as the slider bar is moved from its starting point, from the minimum bet to a predetermined limit established by the game server. In one embodiment, such predetermined limit is $5.00. In another embodiment, that amount may be set by the games server as a pot or double pot bet or such other pot multiple as desired. For Texas Hold'em or other games where a player may go “all in” and bet all chips possessed by the player in his or her stack at the commencement of their turn, the movement of the slider to its furthest point away from the starting point or such other predetermined location in the graphical field will allow the player to select the “all in” bet. Once the slider is moved by continuous touch away from the starting point, and the bet amount increased, the system will allow the amount to be decreased back to the minimum bet by moving the slider bar back toward its original starting point.

In addition, in another embodiment, the “+” and “−” sections of the slider graphic 28 are enabled by the system to detect touch and raise or lower the bet along the range of the minimum and predetermined maximum. Each touch detected may either increase or decrease the betting amount by a predetermined interval set by the game server.

In another embodiment, the chip icon 27 is enabled by the system to detect touch and raise the bet along the range of the minimum and predetermined maximum. Each touch detected may increase the betting amount by a predetermined interval set by the game server.

Once the desired bet amount is selected by using the slider graphic 28 or chip icon 27 to increase and adjust the bet, the player indicates completion and acceptance of the selection by tapping the action indicator button icon 25 or sliding the poker chips icon 27 above the threshold 60. This will cause the game device to effect the required optionset message validation and to send the appropriate selection messages to the game server to allow the game to continue accordingly.

If a bet action is desired and the “BET” graphic is displayed over the action indicator button icon 26, the player first must select the raise amount by manipulating the slider graphic 28 at the bottom of the screen. Sliding of the slide on the graphic 28 will cause the bet amount to increase from $0.00 to the predetermined limit. Thereafter, the player indications completion of the selection by tapping the action indicator button icon 25 or sliding the poker chip icon 27 above the threshold 60. This will cause the game device to effect the required optionset message validation and to send the appropriate selection messages to the game server to allow the game to continue accordingly. In another embodiment, the bet amount is selected by tapping the pot 23.

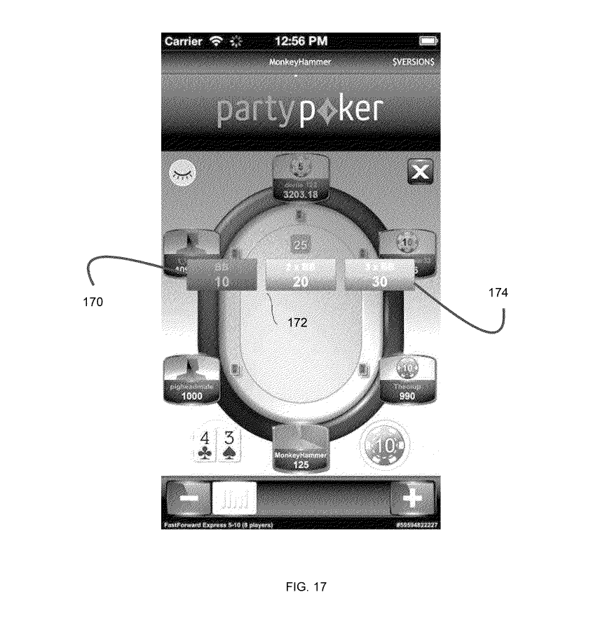

Betting may also be conducted by the player choosing to utilize the pot icon 23. Generally the pot icon at all times will feature a representation of chips and the amount currently in the pot. For instance, with reference to FIG. 17, during pre flop betting rounds, if the system detects a touch of the pot icon 23 for a predetermined continuous interval, three buttons 170, 172, 174 will appear as a result of overlay messages sent by the server to the client and appear on the graphical interface of the device. These buttons, pre-flop, will allow the user to touch and select bet value in amounts equal to Big Blind (BB) (button 170), 2 times BB (button 172) and 3 times BB (button 174). If the system detects a touch within one of the three buttons, that betting action and amount will be implemented. If the system detects a touch anywhere other than within one of the three buttons, the three buttons will disappear and the player betting action will be required to be initiated over again by the user. The game server of the system may be configured such that the betting amount and number of options to be sent via overlay messaging may be varied.

The pot icon 23 may also be utilized, in another embodiment, in post-flop betting rounds. These buttons 170-174, post-flop, will allow the user to touch and select bet value in amounts equal to ½ of the amount of the pot, ¾ of the amount of the pot, or all of the amount of the pot. If the system detects a touch within one of the three buttons, that betting action and amount will be implemented. If the system detects a touch anywhere other than within one of the three buttons, the three buttons will disappear and the player betting action will be required to be initiated over again by the user. The game server of the system may be configured such that the betting amount and number of options to be sent via overlay messaging may be varied.

In addition, the poker chip icon 27 can be animated to provide more visual feedback to the player. In that regard, in addition to the “CALL,” “BET” and “RAISE” overly graphics, the poker chip icon 27 can be made to change color or shape to also indicate a desired action. Thus, e.g., the poker chip icons can be made to cycle through red, white and blue colors together with the cycling through the “CALL,” “BET” and “RAISE” overlays with each color associated with a unique one of these “CALL,” “BET” and “RAISE” actions.

With reference to FIG. 12, an embodiment of a mobile gaming system architecture environment is shown. In the illustrated embodiment, the gaming client 16 includes a plurality of layers 120-128 for interacting with a gaming backend, including a game server 10 described above. The layers 120-128 may be implemented via executing computer readable instructions, such as Javascript™ instructions or the like, read from a non-transitory computer readable medium of the gaming client, for example mobile device 16 of FIG. 1. In particular, the connector layer 120 is a multi-platform client side framework layer that integrates third-party gaming clients with the game server 10. This layer communicates with the gaming backend via a connection service 134 and/or web gateway 136. The connector layer 120 encapsulates a rich set of client infrastructural services enabling developers to quickly create high performance gaming clients on the gaming platform 130 executing one or more game applications 132 of the present embodiment. Major functionalities of the connector layer 120 include:

Seamless connection management with the back-end systems providing high resilience connectivity (HRC);

Provision of Connectivity events & message notification APIs;

Transparent handling of message serialization, dispatching & routing;

Providing plug-in message factories and handlers;

Keeping tab of connection heart beats & taking remedial measures;

Multi-domain handling with high level event notifications; and

Making direct Secured Socket Layer (SSL) socket connections via a native connector.

Alternatively or in addition, connector layer 120 also provides an intermediated gateway for establishing full-duplex connections with backend servers via the web gateway 136.

The accounts layer 122 provides authentication, user registration, login, as well as deposit management functionality by communicating with authentication and deposit management module 138 and POS gateway 140 via the HTTPS protocol. The platform messaging layer 124, in turn, generates messages and associated serializing/de-serializing logic from a standard template. In an embodiment, the platform messaging contract includes a set of interfaces supporting non-gameplay messages common to all products and includes auto-generated glue code. In an embodiment, since this contract is defined by the game platform layer which is generic in nature, the platform messaging layer 124 remains common across a plurality of applications.

The game messaging contract layer 126 comprises a set of interfaces for providing game-play messaging. In an embodiment, this contract is defined by a particular game product and provides messaging corresponding to a game a feature set selected by the game client.

The game layer 128 may be developed and maintained by third-party game developers. This layer encapsulates all game specific user interface and animations. This layer honors the Game and Platform contracts and uses Connector APIs for two-way communication with backend servers.

Game Messaging

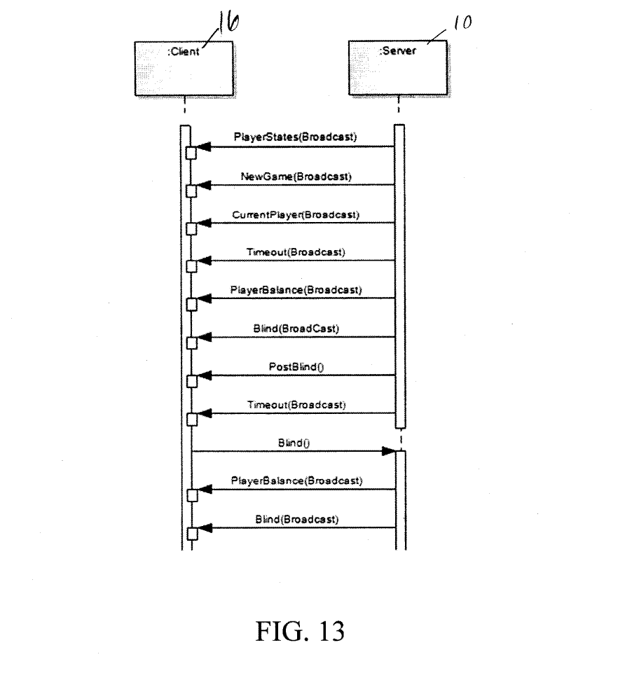

As shown in FIGS. 13-16, during gameplay, gaming client 16 and game server 10 exchange a plurality of messages corresponding to different game actions described above. By way of example, in an embodiment corresponding to the Texas Hold'em poker gameplay the following messages are exchanged during various rounds of betting.

Game Start and Blinds Round Messaging.

Referring to FIG. 13, initially, the game server 10 broadcasts PlayerStates, NewGame, CurrentPlayer and Timeout messages. In particular, the PlayerStates message indicates states of all seated players, such as “out,” “in,” “all in,” “folded,” “blind and fold,” “ante and fold,” “not responding,” and “not in game.” The NewGame message indicates that a new hand is started on the table. The CurrentPlayer message indicates the seat number of the player currently having the game play options, while the TimeOut message indicates the time out period for the current player to take action. In an embodiment, the timer value is displayed on the mobile client 16.

Additionally, the server 10 broadcasts the PlayerBalance message. The PlayerBalance message is broadcast by the game server 10 whenever the table balance for a player is updated. The table balance may be a value corresponding to a balance in cents or other currency.

The game server 10 also sends a PostBlind message to the game client 16 when a player has blind options. The PostBlind message indicates whether the blind is big or small, a blind amount in cents, as well as the timeout duration during which the blinds need to be shown (otherwise the player is seated out). Additionally, the PostBlind message prompts the player to post his or her blind and indicates an amount to be posed along with the blind if the player is seated out for a predetermined duration.

When the client 16 accepts or rejects the PostBlind request from the server 10, it returns a Blind message to the server. The Blind message includes the blind type (e.g., big, small, new player, among others), blind amount, amount to be posted along with blind when the player is seated for a predetermined time, seat number of the player posting the blind, as well as whether the player accepted or rejected the post blind request from the server.

Pre-Flop Round Messaging.

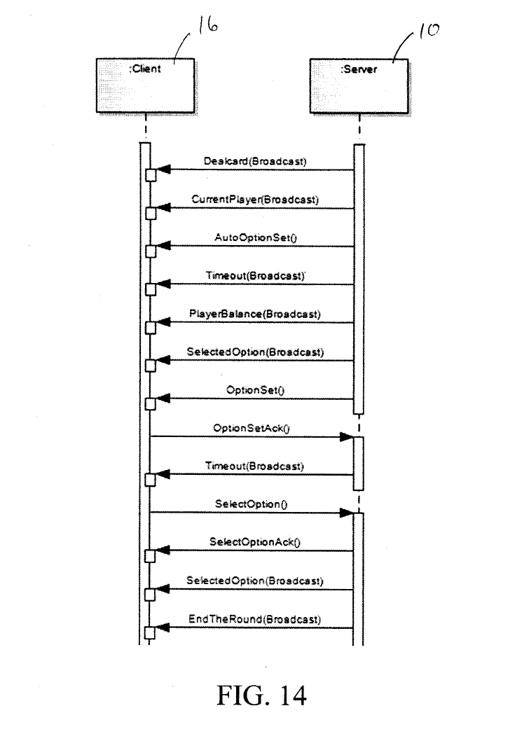

Referring to FIG. 14, during this round, the server 10 sends the instruction to deal cards to the client via a Dealcard message addressed to the current player indicated in the CurrentPlayer message described above. The server 10 also broadcasts a list of advanced options that the current user may select in advance to speed up the gameplay (AutoOptionSet message), as well as initiates a timer for the current user to take action and updates the balance for the current player (PlayerBalance message). Next, the server 10 forwards the OptionSet message to the client 16, which includes a set of actions for the user to take in accordance with the current gameplay (OptionSet message) and receives an acknowledgement of the OptionSet message from the user (OptionSetAck message). The user forwards a SelectOption message to the sever within the Timout timer period to indicate the selected option, which is acknowledged by the server (SelectOptionAck message). At that point the server broadcasts the selected option and ends the round via SelectedOption and EndTheRound messages, respectively.

Flop, Turn, and River Round Messaging.

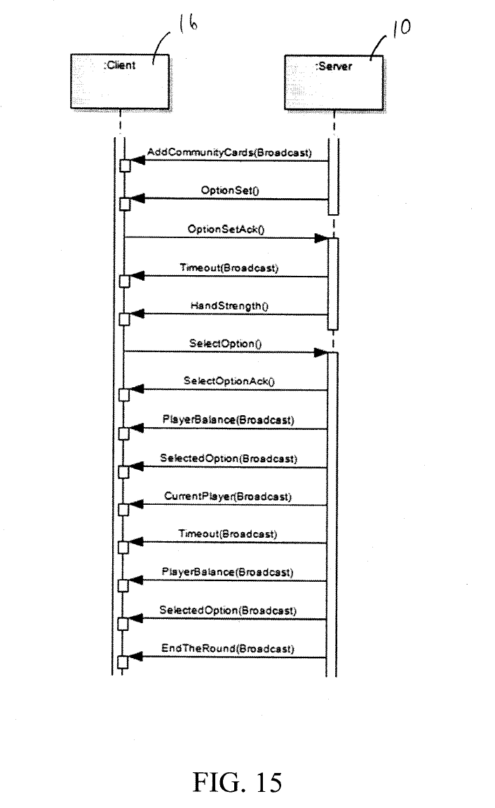

Referring to FIG. 15, the messaging associated with these rounds begins with the server 10 broadcasting community cards to the players via the AddCommunityCards message. The server 10 also forwards the corresponding set of actions to the current user via the OptionSet message, receives and acknowledgement, and broadcasts the current timeout timer. The server 10 subsequently sends a Handstrength message to the client 16 indicating the hand strength, such as by indicating whether the hand is high or low. The game play proceeds as described above when the player selects one of the game play options corresponding to the respective round and the player balance is updated via the PlayerBalance message.

Showdown Round Messaging.

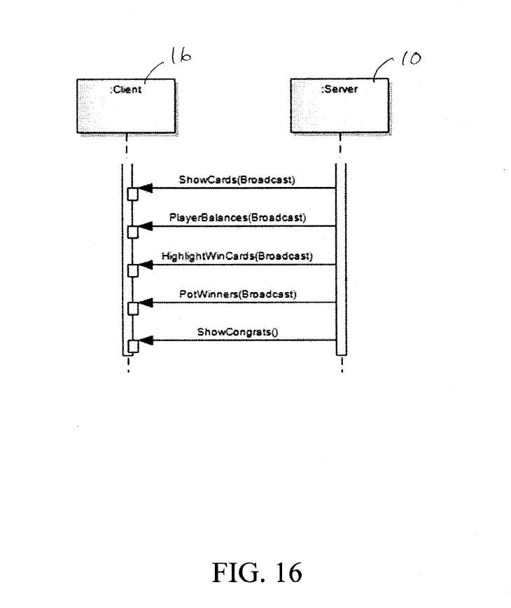

Referring to FIG. 16, in this round, the server 10 broadcasts a ShowCards message which includes the seat number of the player whose cards need to be shown (e.g., by setting a true or false flag corresponding to one of the seat numbers). The ShowCards message further indicates the cards that need to be shown, as well as the hand strength of the player. For instance the hand strength may be indicated as a high hand in case of a Hi-Lo game type or low hand in case of a Hi-Lo game type. The ShowCards message may also indicate the type of cards to show and best cards in case fold and show is enabled. The server 10 then broadcasts respective player balances via the PlayerBalances message. Subsequently, the server broadcasts the HighlightWinCards message which sends the winning cards to the client, as well as the PotWinners message which includes information about pot winners, such as the corresponding sidepot number and winner objects. Finally, sever 10 forwards a ShowCongrats message to the client 16 to instruct the client to display the player's corresponding results.

In implementing these systems and methods to be performed by a suitably programmed client device, it is intended that the client device has a processor and a computer readable medium, wherein the computer readable medium has program code. The systems and methods may also be implemented on a network 14 via which the clients 16-20 and the server computer 10 interconnect and communicate with each other. The program code can be made of one or more modules that carry out instructions for implementing the systems and methods herein. The processor can execute the instructions as programmed in the modules of the program code. For example, the processor can execute instructions for determining, calculating, assigning, obtaining, converting, computing, and variations thereof.

The systems and methods described can be implemented as a computer program product having a tangible computer readable medium having a computer readable program code embodied therein, the computer readable program code adapted to be executed to implement a method for performing the methods described above. Each step or aspect can be performed by a different module, or a single module can perform more than a single step.

The systems and methods described herein as software can be executed on at least one server or network, though it is understood that they can be configured in other ways and retain its functionality. The above-described technology can be implemented on known devices such as a personal computer, a special purpose computer, cellular telephone, personal digital assistant (PDA), a programmed microprocessor or microcontroller and peripheral integrated circuit element(s), and ASIC or other integrated circuit, a digital signal processor, a hard-wired electronic or logic circuit such as a discrete element circuit, a programmable logic device such as a PLD, PLA, FPGA, PAL, or the like. In general, any device capable of implementing the processes described herein can be used to implement the systems and techniques according to this invention.

It is to be appreciated that the various components of the technology can be located at distant portions of a distributed network and/or the Internet, or within a dedicated secure, unsecured and/or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine.

Furthermore, it should be appreciated that the various links connecting the elements can be wired or wireless links, or any combination thereof, or any other known or later developed element(s) that is capable of supplying and/or communicating data to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

Moreover, the disclosed methods may be readily implemented in software, e.g., as a computer program product having one or more modules each adapted for one or more functions of the software, executed on a programmed general purpose computer, cellular telephone, including a smart phone, PDA, tablet, or another mobile and/or handheld device, a special purpose computer, a microprocessor, or the like. In these instances, the systems and methods of this invention can be implemented as a program embedded on a personal computer such as a JAVA®, CGI or Perl script, as a resource residing on a server or graphics workstation, as a routine embedded in a dedicated image system, or the like. The systems and methods of this invention can also be implemented by physically incorporating this system and method into a software and/or hardware system, such as the hardware and software systems of a computer. Such computer program products and systems can be distributed and employ a client-server architecture.

The embodiments described above are intended to be exemplary. One skilled in the art recognizes that numerous alternative components and embodiments that may be substituted for the particular examples described herein and still fall within the scope of the invention.

What is claimed is:

1. A game comprising a graphical user interface displayed on a touch screen of a handheld device, wherein:
player input is effected by way of touches on the touch screen;
the location of the input areas on the touch screen for the touches and the method for obtaining the necessary player game play inputs facilitate game play of a user by using the thumb of the same hand chosen by the player to hold the handheld device in one hand.

2. The game of claim 1, wherein the game is a poker game.

3. The game of claim 2, wherein the poker game is Texas Hold'em.

4. The game of claim 1, wherein each of one or more of touches to which the game is responsive is a slide action and consists of detecting distance of travel of a continuous touch over the touch screen.

5. The game of claim 4, wherein the system detects whether the distance of travel of the continuous touch exceeds a distance threshold.

6. The game of claim 4 wherein at least one of the touches to which the game is response is a tap.

7. The game of claim 6, wherein the calculates whether two taps are performed within an predetermined time period.

8. The game of claim 3, wherein, a hole cards icon is located at a first location where the touch screen is responsive to touch, a poker chip icon is located a second location where the touch screen is responsive to touch and a third icon is located at a third location where the touch screen is responsive to touch.

9. The game of claim 8, wherein:
the hole cards icon and the poker chip icon are located at a bottom portion and at opposite sides of the bottom portion of the touch screen; and
the third icon is located horizontally between the hole cards icon and the poker chip icon and vertically apart from the hole cards icon and the poker chip icon so that the hole cards icon, the poker chip icon and the third icon appear at respective corners of a triangle.

10. A game comprising the steps of:
causing display of a graphical user interface on a touch screen of a handheld device;
causing display of a plurality of icons on the graphical user interface at locations where detection of touching of the touch is enabled;
the location of the input areas on the touch screen for the touches and the method for obtaining the necessary player game play inputs facilitate game play of a user by using the thumb of the same hand chosen by the player to hold the handheld device in one hand.

11. The game of claim 10, wherein the game is a poker game.

12. The game of claim 11, wherein the poker game is Texas Hold'em.

13. The game of claim 10, wherein each of one or more of touches to which the game is responsive is a slide action and consists of detecting a distance of travel of a continuous touch over the touch screen.

14. The game of claim 13, comprising the step of detecting whether the distance of travel of the continuous touch exceeds a distance threshold.

15. The game of claim 4 wherein at least one of the touches to which the game is response is a tap.

16. The game of claim 15, comprising the step of calculating whether two taps are performed within an predetermined time period.

17. The game of claim 3, wherein the step of causing the display of a plurality of icons comprising causing the display of a hole cards icon located at a first location where the touch screen is responsive to touch, a poker chip icon located a second location where the touch screen is responsive to touch and a third icon located at a third location where the touch screen is responsive to touch.

18. The game of claim 17, wherein:
the hole cards icon and the poker chip icon are located at a bottom portion and at opposite sides of the bottom portion of the touch screen; and
the third icon is located horizontally between the hole cards icon and the poker chip icon and vertically apart from the hole cards icon and the poker chip icon so that the hole cards icon, the poker chip icon and the third icon appear at respective corners of a triangle.

19. A networked game, comprising:
a game server that controls game play and sends game state information to connected handheld devices of players;
a network via which the handheld device can be connected to the game server; and
the handheld devices connected to the game server,
wherein,
each handheld device comprises a touch screen,
for each handheld device, player input is effected by way of touches on the touch screen;
the location of the input areas on the touch screen for the touches and the method for obtaining the necessary player game play inputs facilitate game play of a user by using the thumb of the same hand chosen by the player to hold the handheld device in one hand.

20. The networked game of claim 19, wherein the game is a poker game.

21. The networked game of claim 20, wherein the poker game is Texas Hold'em.

22. The networked game of claim 19, wherein each of one or more of touches to which the game is responsive is a slide action and consists of detecting distance of travel of a continuous touch over the touch screen.

23. The networked game of claim 22, wherein the system detects whether the distance of travel of the continuous touch exceeds a distance threshold.

24. The networked game of claim 22 wherein at least one of the touches to which the game is response is a tap.

25. The networked game of claim 24, wherein the game calculates whether two taps are performed within an predetermined time period.

26. The networked game of claim 3, wherein, for each handheld device, a hole cards icon is located at a first location where the touch screen is responsive to touch, a poker chip icon is located a second location where the touch screen is responsive to touch and a third icon is located at a third location where the touch screen is responsive to touch.

27. The networked game of claim 26, wherein for each handheld device:
the hole cards icon and the poker chip icon are located at a bottom portion and at opposite sides of the bottom portion of the touch screen; and
the third icon is located horizontally between the hole cards icon and the poker chip icon and vertically apart from the hole cards icon and the poker chip icon so that the hole cards icon, the poker chip icon and the third icon appear at respective corners of a triangle.

28. A graphical user interface for conducting card gameplay via a mobile device comprising:
a plurality of controls responsive to touch input from a user comprising:
a first control configured to initiate a first card gameplay action;
a second control configured to initiate a second card gameplay action; and
a third control configured to complete at least one of the first and second card gameplay actions upon receiving the touch input from the user within a predetermined time from initiating the respective card gameplay action via at least one of the first and second controls.

29. The graphical user interface of claim 28 wherein the card gameplay is a poker gameplay.

30. The graphical user interface of claim 29 wherein the first control implements a fold action of the poker game.

31. The graphical user interface of claim 29 wherein the second control implements at least one of a cull, bet, and raise action of the poker game.

32. The graphical user interface of claim 28 wherein the third control indicates one of the first and second card gameplay actions initiated by respective first and second controls.

33. The graphical user interface of claim 28 wherein the third control receives sliding touch input from the user.

34. The graphical user interface of claim 28 wherein the third control receives a tapping touch input from the user.
